(19) United States
(12) Patent Application Publication
(10) Pub. No.: US 2015/0220959 A1
(43) Pub. Date: Aug. 6, 2015

(54) Adaptable and Intelligent User Incentive System

(71) Applicant: LiveDial, LLC, Teaneck, NJ (US)

(72) Inventors: Yali Elkin, Teaneck, NJ (US); Yigal M. Marcus, Teaneck, NJ (US)

(21) Appl. No.: 14/612,921

(22) Filed: Feb. 3, 2015

Related U.S. Application Data
(60) Provisional application No. 61/935,066, filed on Feb. 3, 2014.
(60) Provisional application No. 61/944,393, filed on Feb. 25, 2014.

(51) Int. Cl. G06Q 30/02

(52) U.S. Cl. CPC G06Q 30/0226

(57) ABSTRACT

Novel tools and techniques are provided for implementing adaptable and intelligent user incentives programs for reward systems and/or for identifying, matching, and/or grouping users (in some cases, based on common characteristics of the users). The user incentive system is dynamic, highly customizable, and rely on analyses of usage patterns of specific users or groups of users with similar demographics. The system generates and implements a customized rewards program for the user based on such analyses, and tracks the behavior of the user in response to such implementation, then updates the rewards program accordingly. In some embodiments, grouping users based on profile characteristics, user response characteristics, and/or historical characteristics allows users to quickly request consumer responses and/or opinions, or to extract data from previously elicited responses, from other users “like” the user, and to report such responses to the user on a real-time basis, for answering polls or purchasing items, etc.

### CROSS-REFERENCES TO RELATED APPLICATIONS

This application claims priority to U.S. Patent Application Ser. No. 61/935,066 (the “'066 application”), filed Feb. 3, 2014 by Yali Elkin et al. (attorney docket no. 0631.01PR), entitled, “Adaptable and Intelligent User Incentive System” and to U.S. Patent Application Ser. No. 61/944,393 (the “'393 application”), filed Feb. 25, 2014 by Yigal M. Marcus (attorney docket no. 0631.02PR), entitled, “Method and System for Adaptable and Intelligent Consumer Matching and Match Result Distribution to Users.”

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a device, system, method, and computer software for generating user incentives for reward systems or for identifying, matching, and/or grouping users, and, more particularly, to a device, system, method, and computer software for adaptably and intelligently generating user incentives for reward systems or for adaptably and intelligently identifying, matching, and/or grouping users based on common characteristics.

### BACKGROUND

People often wonder how different they are from their peers who are most similar to them. In addition, consumers are most influenced by people who are members of their social network and community—but are most intrigued and should be most influenced by the opinions of those who are most similar to them. Furthermore, the Internet contains many reviews and opinions about an unlimited number of items—but users may only care about the opinions of users who are most similar to them.

Current systems, however, do not enable users to anonymously target other users based on similar profile characteristics. Users must be previously known to a poll/survey publisher and/or retailer to enable profile matching.

In addition, aggregation of similar users (and/or profiles of similar users) might be used to improve upon and/or enhance customer affinity reward systems. Current customer affinity reward systems, however, are static and appear in reward programs for many industries, including, e.g., in airline frequent flyer programs, in credit card points, in mobile applications (e.g., Waze™, or the like), frequent buyers' clubs, and/or the like. Such current programs are static, in that there is no level of adaptability for specific, coveted target users of customers. Further, such programs do not utilize the matching/grouping functionality discussed above.

Hence, there is a need for more robust and scalable user incentive and/or reward system solutions and/or more robust and scalable solutions for identifying, matching, and/or grouping users or for identifying, matching, and/or grouping reviews and opinions of users.

### BRIEF SUMMARY

Various embodiments provide techniques for implementing adaptable and intelligent user incentives programs for reward systems.

Various embodiments might also provide techniques for implementing adaptable and intelligent identification, matching, and/or grouping of users (and/or reviews and opinions of users), which, in some cases, is based on common characteristics of the users—including, but not limited to, common demographic, psychographic, and/or socioeconomic characteristics (collectively, “profile characteristics”); similar poll/survey response data (collectively, “user response characteristics”); and/or common purchase histories, common browser histories, common search histories, common books/newspapers/magazine subscriptions, common entertainment programs/venues, and/or meta data of the same (collectively, “historical characteristics”).

Various embodiments enable users to quickly elicit or request consumer responses and/or opinions, or to extract data from responses previously elicited, and to report them to the user on a real-time basis. The data requested can include, without limitation, shopping preferences, opinions, online and offline purchases, business reviews, survey/poll responses, medical history, gaming results, sports preferences, interpersonal proclivities, social preferences, dating preferences, entertainment and leisure preferences, website visitation patterns, history, and/or the like.

In a particular set of embodiments, the identification, matching, and/or grouping functionality discussed above may be applied to user incentive programs. User incentive programs are at the heart of fueling increased usage of software applications—particularly, mobile applications—but also credit card usage points, airline affinity programs, shopper points, etc. Many programs issue “rewards” or “points” to incentivize users to use applications or services with greater regularity, or to make purchases with greater regularity. Thus far, reward systems are static (i.e., a specific, finite number of points are rewarded for specific tasks).

The reality for many publishers of applications, however, is that users vary in their importance to the publisher. Some users are more important (i.e., trend setters, more coveted demographic, etc.) than others, and some users may require a different level of reward to stimulate a desired action (e.g., to book a flight, purchase a large ticket item, etc.).

The various embodiments manage user reward systems so that the rewards issued are dynamically and automatically adjustable based on the following: (1) the importance of the target user; and (2) the user's history of reacting to particular reward levels. For example, if a vendor targeted a specific subset of users for a particular poll, and it sought to quickly achieve a level of statistical significance in its results, it may adjust higher the number of points for the demographic of users that are thus far under-represented in the sample. It may adjust the level of points issued by analyzing the user's history of action at specific point levels, and those of people with similar demographic, socioeconomic, and/or psychographic profiles.

In this manner, users may be more smartly incentivized with more powerful and more meaningful reward systems to encourage a particular action. In some embodiments, users may more quickly be targeted and incentivized, so that a statistically significant and representative result can be generated. In some aspects, the identification, matching, and/or grouping functionality may be implemented to generate more user-significant and user-focused user incentive programs.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

Various embodiments described herein, while embodying (in some cases) software products, computer-performed methods, and/or computer systems, represent techniques that are not merely abstract ideas, such as a fundamental or long-standing economic practice, a method of organizing human activity, an idea itself, or a mathematical relationship. To the extent that any abstract concepts are present in the various embodiments (for example if incentivizing users or reporting to users what similar other users have purchased or given opinion on are deemed to utilize or fall under an economic practice, a method of organizing human activity, or an idea itself, and thus might be deemed to be directed to an abstract idea), those concepts utilize techniques and systems (particularly as claimed) that amount to significantly more than the abstract idea. In particular, the various embodiments are directed to techniques that require the mass-scale data aggregation and analysis of mass-scale data for near-instantaneously generating and updating customized rewards programs for extremely targeted user incentivization, based at least in part on user behavior and history and at least in part on behavior analysis of a plurality of users having one or more of demographic characteristics, psychographic characteristics, or socioeconomic characteristics in common with the user. Some embodiments are directed to techniques that require mass-scale data aggregation and analysis of mass-scale data for near-instantaneously gathering opinions and/or responses from a plurality of users having one or more of demographic characteristics, psychographic characteristics, or socioeconomic characteristics in common with the user, the opinions and/or responses helping the user when answering polls, purchasing items, and/or the like. These mass-scale data aggregation and analyses of mass-scale data for near-instantaneous user incentive generation or modification, as well as for near-instantaneous collection or reporting to the user of opinions and/or responses of a plurality of users having common characteristics as the user necessarily require mass-scale solutions rooted in computer technology that cannot have been performed in a pre-Internet world. Moreover, these solutions as embodied herein are not mere recitation of performance of some business practice known from the pre-Internet world along with the requirement to perform it on the Internet. In fact, as mentioned above current reward systems are static and not dynamic (as described herein with respect to the various embodiments).

Further, those concepts above can be implemented as described herein by devices, software, systems, and methods that involve specific novel functionality (e.g., steps or operations), such as implementing mass-scale data aggregation and mass-scale analysis to provide near-instantaneous generation and updating of customized user incentive programs that are based at least in part on the user's behavior and history and at least in part on characteristics of a plurality of users sharing common characteristics with the user, implementing mass-scale data aggregation and mass-scale analysis to provide near-instantaneous reporting to a user of opinions and/or responses of a plurality of users sharing common characteristics with the user, and/or the like, to name a few examples, that extend beyond mere conventional computer processing operations. This functionality can produce tangible results outside of the implementing computer system, including, merely by way of example, automatically generating customized, dynamic, and targeted user incentives that are automatically communicated to the user (e.g., via e-mail, text messages, chat messages, SMS messages, MMS messages, or the like that are automatically generated and populated with the user incentives), automatically generating reports containing responses and/or opinions of a plurality of users sharing common characteristics with the user that are automatically communicated to the user (e.g., via e-mail, text messages, chat messages, SMS messages, MMS messages, or the like that are automatically generated and populated with the user incentives), and/or the like.

In an aspect, a method might comprise receiving, with a computer, first data comprising data indicating usage of reward programs by a user, analyzing, with the computer, the received first data, and determining, with the computer, regularity and timing with which the user utilizes reward programs, based on the analysis of the first data. In some cases, the method might further comprise determining, with the computer, previous reward levels at which the user has previously been willing to perform first targeted actions and determining timing of the first targeted actions, based on the analysis of the first data. The method might also comprise receiving, with the computer, second data comprising data indicating usage of reward programs by a plurality of users having one or more of demographic characteristics, psychographic characteristics, or socioeconomic characteristics in common with the user, analyzing, with the computer, the received second data, and determining, with the computer, an average rewards level at which the plurality of users were successfully stimulated to perform second targeted actions, based on the analysis of the second data. In some embodiments, the method might further comprise generating, with the computer, a customized rewards program for the user, the customized rewards program being designed to incentivize the user to perform third targeted actions, implementing the customized rewards program, tracking, with the computer, behavior of the user in response to implementation of the customized rewards program, and storing, with the computer, the tracked behavior of the user in a data storage device in communication with the computer.

In some embodiments, the computer might be a server in a network. According to some embodiments, the customized rewards program might comprise step-wise incremental rewards incentives. The step-wise incremental rewards incentives might comprise a first level corresponding to the average rewards level of the plurality of users, a second level corresponding to an average of the previous reward levels of the user, and a third level corresponding to a predetermined maximum reward level associated with the first targeted actions. In some cases, implementing the customized rewards program might comprise sending, with the computer, a first offer to the user and determining, with the computer, whether the user accepted the first offer and performed the third targeted actions. The first offer might comprise an offer to reward the user at the first level if the user performs the third targeted actions. Based on a determination that the user did not accept the first offer, implementing the customized rewards program might comprise sending, with the computer, a second offer to the user. The second offer might comprise an offer to reward the user at the second level if the user performs the third targeted actions. Implementing the customized rewards program might further comprise determining, with the computer, whether the user accepted the second offer and performed the third targeted actions, and, based on a determination that the user did not accept the second offer, sending, with the computer, a third offer to the user. The third offer might comprise an offer to reward the user at the third level if the user performs the third targeted actions.

According to some embodiments, implementing the customized rewards program might comprise implementing the customized rewards program over a first period. The method might further comprise determining whether a deadline exists for performing the third targeted actions, and implementing the customized rewards program might further comprise, based on a determination that a deadline exists for performing the third targeted actions, implementing the customized rewards program over a second period, the second period being shorter than the first period. In some cases, the first targeted actions, the second targeted actions, and the third targeted actions might be similar targeted actions. In some instances, one or more of the first targeted actions, the second targeted actions, or the third targeted actions might comprise at least one of completing a poll, completing a survey, visiting a webpage, endorsing a product, endorsing a service, endorsing a brand, endorsing a company, purchasing a product, or subscribing to a service.

In another aspect, a method might comprise analyzing, with a computer, first data to determine a first level, and analyzing, with the computer, second data to determine a second level. The first data might comprise data indicating first behavior of a user in response to implementation of a plurality of first reward programs, while the second data might comprise data indicating second behavior of a plurality of users in response to implementation of a plurality of second reward programs. The plurality of users might have one or more of demographic characteristics, psychographic characteristics, or socioeconomic characteristics in common with the user.

The method might further comprise generating, with the computer, a customized rewards program for the user that is designed to incentivize the user to perform first targeted actions, based at least in part on the analysis of the first data and the analysis of the second data, and implementing the customized rewards program. In some cases, the method might also comprise tracking, with the computer, behavior of the user in response to implementation of the customized rewards program, and storing, with the computer, the tracked behavior of the user in a data storage device in communication with the computer.

According to some embodiments, the first level might correspond to an average level at which the user has previously been willing to perform second targeted actions. The second level might correspond to an average level at which the plurality of users were successfully stimulated to perform third targeted actions. In some cases, implementing the customized rewards program might comprise sending, with the computer, a first offer to the user. The first offer might comprise an offer to reward the user at the second level if the user performs the first targeted actions. Implementing the customized rewards program might also comprise, based on a determination that the user did not accept the first offer, sending, with the computer, a second offer to the user. The second offer might comprise an offer to reward the user at the first level if the user performs the first targeted actions. Implementing the customized rewards program might further comprise, based on a determination that the user did not accept the second offer, sending, with the computer, a third offer to the user. The third offer might comprise an offer to reward the user at a third level if the user performs the first targeted actions. The third level might correspond to a predetermined maximum reward level associated with the first targeted actions.

In some embodiments, wherein implementing the customized rewards program might comprise implementing the customized rewards program over a first period, and, based on a determination that a deadline exists for performing the third targeted actions, implementing the customized rewards program over a second period. The second period might be shorter than the first period. In some cases, the first targeted actions, the second targeted actions, and the third targeted actions might be similar targeted actions. In some instances, one or more of the first targeted actions, the second targeted actions, or the third targeted actions might comprise at least one of completing a poll, completing a survey, visiting a webpage, endorsing a product, endorsing a service, endorsing a brand, endorsing a company, purchasing a product, or subscribing to a service.

In yet another aspect, an apparatus might comprise at least one processor and a computer readable storage medium in communication with the at least one processor. The computer readable storage medium might have stored thereon computer software, the computer software comprising a set of instructions that, when executed by the at least one processor, causes the apparatus to perform one or more operations. The set of instructions might comprise instructions to analyze first data to determine a first level, and instructions to analyze second data to determine a second level. The first data might comprise data indicating first behavior of a user in response to implementation of a plurality of first reward programs. The second data might comprise data indicating second behavior of a plurality of users in response to implementation of a plurality of second reward programs. The plurality of users might have one or more of demographic characteristics, psychographic characteristics, or socioeconomic characteristics in common with the user. The set of instructions might further comprise instructions to generate a customized rewards program for the user that is designed to incentivize the user to perform first targeted actions, based at least in part on the analysis of the first data and the analysis of the second data, and instructions to implement the customized rewards program. The set of instructions might also comprise instructions to track behavior of the user in response to implementation of the customized rewards program, and instructions to store the tracked behavior of the user in a data storage device in communication with the apparatus.

In still another aspect, a system might comprise a data storage device and a computer in communication with the data storage device. The computer might comprise at least one processor and a computer readable storage medium in communication with the at least one processor. The computer readable storage medium might have stored thereon computer software, the computer software comprising a set of instructions that, when executed by the at least one processor, causes the computer to perform one or more operations. The set of instructions might comprise instructions to analyze first data to determine a first level, and instructions to analyze second data to determine a second level. The first data might comprise data indicating first behavior of a user in response to implementation of a plurality of first reward programs. The second data might comprise data indicating second behavior of a plurality of users in response to implementation of a plurality of second reward programs. The plurality of users might have one or more of demographic characteristics, psychographic characteristics, or socioeconomic characteristics in common with the user. The set of instructions might further comprise instructions to generate a customized rewards program for the user that is designed to incentivize the user to perform first targeted actions, based at least in part on the analysis of the first data and the analysis of the second data, and instructions to implement the customized rewards program. The set of instructions might also comprise instructions to track behavior of the user in response to implementation of the customized rewards program, and instructions to store the tracked behavior of the user in the data storage device.

Merely by way of example, in some embodiments, the system might further comprise a plurality of retail computers associated with a plurality of retailers. The first data and second data might be received by the computer from the plurality of retail computers. In some cases, the system might further comprise a plurality of user devices each associated with one of the user or one of the plurality of users, and the first data and second data might be received by the computer from the plurality of user devices.

In another aspect, a method might comprise generating, with a computer, a customized rewards program for a user, and implementing the customized rewards program.

In an aspect, a method might comprise receiving, with a computer, a request from a first user to retrieve information associated with users who are similar to a second user. In some cases, the method might further comprise receiving, with the computer, information associated with the second user, and receiving, with the computer, information associated with a plurality of third users. The method might also comprise analyzing, with the computer, the information associated with the plurality of third users to identify one or more third users who are similar to the second user, based at least in part on the retrieved information associated with the second user. In some instances, the method might further comprise sending, with the computer and to the first user, a report indicating information associated with the one or more third users identified to be similar to the second user.

In some embodiments, the second user and the first user might be the same user. In some cases, the second user might be one of a significant other (e.g., a spouse, a boyfriend, a girlfriend, and/or the like) of the first user, a relative of the first user, a friend of the first user, an acquaintance of the first user, or a co-worker of the first user.

In some instances, the first user might be one of a retailer or a representative of the retailer, and the second user might be a customer of the first user. The method, in some embodiments, might further comprise receiving, with the computer, a request from the first user to send the report to the second user, and in response to receiving the request, sending, with the computer and to the second user, the report indicating information associated with the one or more third users identified to be similar to the second user. In some aspects, the method might further comprise generating, with the computer, a customized rewards program for the second user based at least in part on the report indicating information associated with the one or more third users identified to be similar to the second user, and implementing the customized rewards program.

According to some embodiments, the request from the first user to retrieve information associated with users who are similar to the second user might comprise the first user performing an action selected from a group consisting of actuating a hard-button, actuating a soft-button, actuating a virtual button, clicking on a link, and initiating a voice command.

In some embodiments, the information associated with the second user might comprise at least one of first profile characteristics, first user-response characteristics, or first historical characteristics, and the information associated with the plurality of third users might comprise at least one of second profile characteristics, second user-response characteristics, or second historical characteristics. Analyzing the information associated with the plurality of third users to identify the one or more third users who are similar to the second user might, in some instances, comprise at least one of determining whether the first profile characteristics of the second user match with the second profile characteristics of any of the plurality of third users, determining whether the second user-response characteristics of the second user match with the second user-response characteristics of any of the plurality of third users, or determining whether the first historical characteristics of the second user match with the second historical characteristics of any of the plurality of third users.

Each of the first profile characteristics or the second profile characteristics might comprise characteristics selected from a group consisting of demographic characteristics, psychographic characteristics, and socioeconomic characteristics. Each of the second user-response characteristics or the second user-response characteristics might comprise characteristics selected from a group consisting of poll response data and survey response data. Each of the first historical characteristics or the second historical characteristics might comprise characteristics selected from a group consisting of product purchase histories, service purchase histories, book purchase histories, library book loan histories, newspaper subscription histories, magazine subscription histories, entertainment program subscription histories, entertainment program venue ticket purchase histories, Internet browser histories, search histories, voting records, charitable donation records, online dating patterns, meta data associated with product purchase histories, meta data associated with service purchase histories, meta data associated with book purchase histories, meta data associated with library book loan histories, meta data associated with newspaper subscription histories, meta data associated with magazine subscription histories, meta data associated with entertainment program subscription histories, meta data associated with entertainment program venue ticket purchase histories, meta data associated with Internet browser histories, meta data associated with search histories, meta data associated with voting records, meta data associated with charitable donation records, and meta data associated with online dating patterns.

In some embodiments, receiving information associated with the second user might comprise retrieving at least one of first profile characteristics, first user-response characteristics, or first historical characteristics from one or more first data stores. In other embodiments, receiving information associated with the second user might comprise sending one or more requests to the second user to provide information regarding at least one of first profile characteristics, first user-response characteristics, or first historical characteristics. Likewise, receiving information associated with the plurality of third users, in some cases, might comprise retrieving at least one of second profile characteristics, second user-response characteristics, or second historical characteristics from one or more second data stores. In other cases, receiving information associated with the plurality of third users might comprise sending requests to at least one third user of the plurality of third users to provide information regarding at least one of second profile characteristics, second user-response characteristics, or second historical characteristics.

According to some embodiments, sending the report indicating information associated with the one or more third users identified to be similar to the second user might comprise aggregating at least one of second profile characteristics, second user-response characteristics, or second historical characteristics. The report indicating information associated with the one or more third users identified to be similar to the second user might comprise at least one of one or more graphs, one or more spreadsheets, one or more comma-separated values (“CSV”) files, one or more text files, one or more images, one or more e-mail messages, one or more text messages, one or more chat messages, one or more short message service (“SMS”) messages, or one or more multi-media messaging service (“MMS”) messages. The information associated with the one or more third users identified to be similar to the second user might comprise at least one of product reviews, service reviews, poll responses, survey responses, book reviews, magazine reviews, newspaper reviews, entertainment program reviews, entertainment venue reviews, Internet website reviews, political commentaries, charity reviews, or dating website reviews.

In another aspect, an apparatus might comprise at least one processor and a computer readable storage medium in communication with the at least one processor. The computer readable storage medium might have stored thereon computer software. The computer software might comprise a set of instructions that, when executed by the at least one processor, causes the apparatus to perform one or more operations. The set of instructions might comprise instructions to receive a request from a first user to retrieve information associated with users who are similar to a second user, instructions to receive information associated with the second user, and instructions to receive information associated with a plurality of third users. The set of instructions might also comprise instructions to analyze the information associated with the plurality of third users to identify one or more third users who are similar to the second user, based at least in part on the retrieved information associated with the second user. The set of instructions might further comprise instructions to send a report indicating information associated with the one or more third users identified to be similar to the second user.

In yet another aspect, a method might comprise analyzing, with a computer, information associated with the plurality of first users to identify one or more first users who are similar to a second user, based at least in part on information associated with the second user.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for implementing adaptable and intelligent user incentives programs for reward systems, in accordance with various embodiments.

FIG. 2 is a general schematic flow diagram illustrating a method for implementing adaptable and intelligent user incentives programs for reward systems, in accordance with various embodiments.

FIG. 3 is a general schematic flow diagram illustrating another method for implementing adaptable and intelligent user incentives programs for reward systems, in accordance with various embodiments.

FIG. 4 is a general schematic diagram illustrating a system for implementing adaptable and intelligent identification, matching, and/or grouping of users, in accordance with various embodiments.

FIGS. 5A-5E are general schematic diagrams illustrating levels of matching for implementing adaptable and intelligent identification, matching, and/or grouping of users, in accordance with various embodiments.

FIG. 6 is a general schematic flow diagram illustrating a method for implementing adaptable and intelligent identification, matching, and/or grouping of users, in accordance with various embodiments.

FIG. 7 is a block diagram illustrating an exemplary computer architecture, in accordance with various embodiments.

FIG. 8 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments provide techniques for implementing adaptable and intelligent user incentives programs for reward systems—in some cases, utilizing the identification, matching, and/or grouping functionality discussed below.

User incentive programs are at the heart of fueling increased usage of software applications—particularly, mobile applications—but also credit card usage points, airline affinity programs, shopper points, etc. Many programs issue “rewards” or “points” to incentivize users to use applications or services with greater regularity, or to make purchases with greater regularity. Thus far, reward systems are static (i.e., a specific, finite number of points are rewarded for specific tasks).

The reality for many publishers of applications, however, is that users vary in their importance to the publisher. Some users are more important (i.e., trend setters, more coveted demographic, etc.) than others, and some users may require a different level of reward to stimulate a desired action (e.g., to book a flight, purchase a large ticket item, etc.).

The various embodiments manage user reward systems so that the rewards issued are dynamically and automatically adjustable based on the following: (1) the importance of the target user; and (2) the user's history of reacting to particular reward levels. For example, if a vendor targeted a specific subset of users for a particular poll, and it sought to quickly achieve a level of statistical significance in its results, it may adjust higher the number of points for the demographic of users that are thus far under-represented in the sample. It may adjust the level of points issued by analyzing the user's history of action at specific point levels, and those of people with similar demographic, socioeconomic, and/or psychographic profiles.

In this manner, users may be more smartly incentivized with more powerful and more meaningful reward systems to encourage a particular action. In some embodiments, users may more quickly be targeted and incentivized, so that a statistically significant and representative result can be generated.

In some embodiments, the adaptable and intelligent user incentive system may increase the likelihood that users will partake of the hosting business by better understanding what makes users take notice and take action. The greatest challenge of existing rewards systems is that they are “one size fits all” programs. Invariably, more regular customers get more of the affinity program rewards, and new or less regular customers (who are more heavily targeted, as all businesses want to expand their customer base) get less of the reward system. The various embodiments will adapt rewards to specific users, in order to encourage them to participate in the program.

Unlike current systems, which are static with no customization (where any changes are made for large groups of diverse users), the system according to the various embodiments is inherently customizable. Unlike current systems, which do not study usage patterns of specific users or groups of users with similar demographics, the system according to the various embodiments is predicated on that type of analysis.

Various embodiments might also provide techniques for implementing adaptable and intelligent identification, matching, and/or grouping of users (and/or reviews and opinions of users), which, in some cases, is based on common characteristics of the users—including, but not limited to, common demographic, psychographic, and/or socioeconomic characteristics (collectively, “profile characteristics”); similar poll/survey response data (collectively, “user response characteristics”); and/or common purchase histories, common browser histories, common search histories, common books/newspapers/magazine subscriptions, common entertainment programs/venues, and/or meta data of the same (collectively, “historical characteristics”).

Various embodiments enable users to quickly elicit or request consumer responses and/or opinions, or to extract data from responses previously elicited, and to report them to the user on a real-time basis. The data requested can include, without limitation, shopping preferences, opinions, online and offline purchases, business reviews, survey/poll responses, medical history, gaming results, sports preferences, interpersonal proclivities, social preferences, dating preferences, entertainment and leisure preferences, website visitation patterns, history, and/or the like.

In some embodiments, users that are similar to a requesting user might be identified. Information from or about such users might be elicited or requested, either actively or passively. Such information may then be reported back to the requesting user.

In various embodiments, the method and system might identify and match users or consumers who have similar or identical demographic, psychographic, and/or socioeconomic characteristics, or who share other common characteristics as those of the user (e.g., they answered similarly in surveys/polls, read similar books/newspapers, prefer similar entertainment programs or venues, and/or the like).

An example of requesting historical data (i.e., by utilitizing a “pull” functionality) might include a user participating in an online poll seeking to know how respondents similar to himself or herself responded to that poll. By selecting a “like me” (or “similar to me”) functionality, the results of those similar respondents might be requested and reported to the user. In another example, a user who makes an online or in-store purchase of an item, and wishes to know before checkout the opinions and/or product reviews of those most similar to him or her, might select the “like me” functionality, to enable retrieval and review of data from similar users who have purchased or considered purchasing those items. In an example of a user requesting dynamic (i.e., real-time) data (i.e., by utilizing a “push” functionality), a user drafting a poll, e-mail message, text message, and/or other similar communication medium, and wishing to target those who are most similar to him or her, can select the “like me” functionality. In response to such selection, his or her request might be forwarded to those most similar to him or her, and the subsequent responses might be reported back to him or her.

Based at least in part on such functionality, the system can enable users to quickly target other users that are most similar to the user (whether known or unknown to the user by name, e-mail, or the like), and to view the response of the other users (who are most similar to the user) (whether known or unknown to the user). This provides a powerful tool to users, enabling them to elicit response from people who are most influential (i.e., most similar) to the users. As a result, a more engaging and intriguing experience may be create for the users by giving the users the ability to measure the opinions, perspectives, and/or sentiments of other users who are most similar to them, as determined by the matching of data (e.g., as discussed above). The users may also see how other users most similar to them have responded to any polls or surveys, and/or see how the other users (most similar to them) have behaved previously in similar situations (including, but not limited to, buying patterns, and/or the like).

Further, such functionality as discussed above may be implemented in any forum where the opinions of those who influence are to be viewed. For example, online and in-store retailers (e.g., Amazon.com, BestBuy.com, Walmart.com, Macys.com, Best Buy, Walmart, Macy's, Kmart, JCPenny, and/or the like) might use the “like me” functionality to allow a consumer to see how product reviewers who are most like the consumer report about the goods being considered for purchase by the consumer. Further, such online and in-store retailers might aggregate such reports by similar people for incentivizing similar consumers, e.g., in a manner as described below and in detail in the '066 Application, the entire disclosure of which has already been incorporated herein by reference in its entirety for all purposes.

Polling/survey companies (e.g., Survey Monkey, and/or the like) might want to aggregate the responses of users who are similar to each other. Dating sites might week to compare the dating patterns amongst similar types of people. Product review sites (e.g., Angie's List, Yelp, YB.com, Amazon.com, and/or the like) may wish to filter results for any viewer based on other viewers who are similar to the reviewer. News sites (e.g., CNN.com, FoxNews.com, MSNBC.com, and/or the like) may want to report results of viewers who are most similar to the responders to online polls.

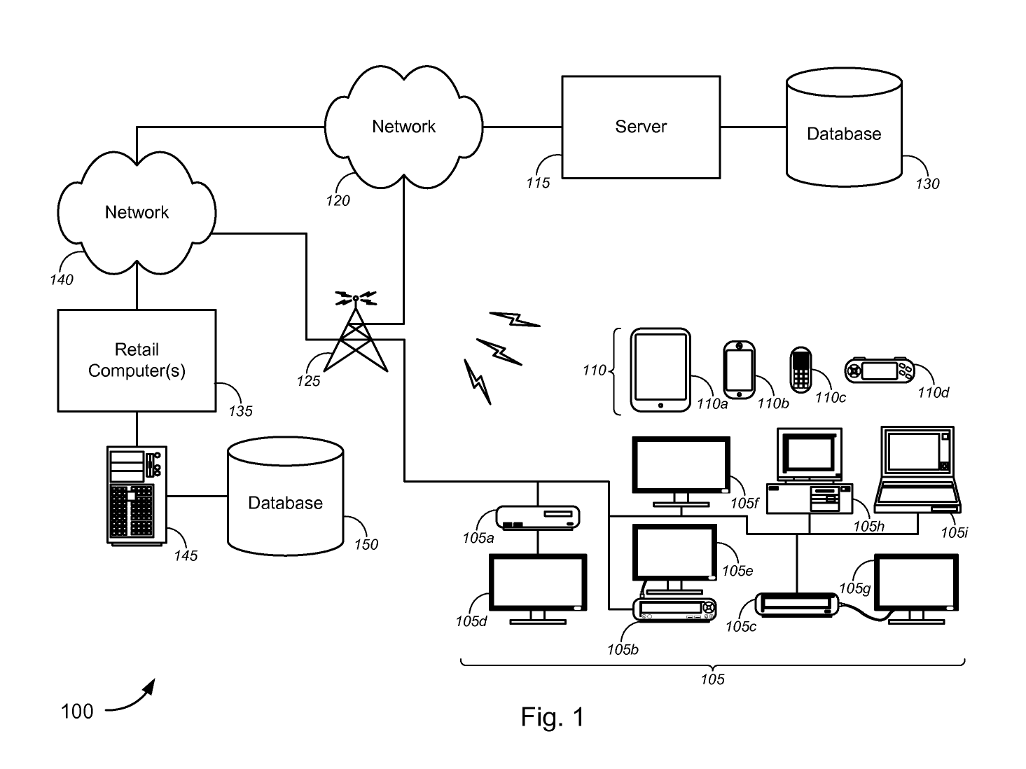

We now turn to the embodiments as illustrated by the drawings. FIGS. 1-8 illustrate some of the features of the method, system, and apparatus for implementing adaptable and intelligent user incentives programs for reward systems or for implementing adaptable and intelligent identification, matching, and/or grouping of user, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

User Incentive Program

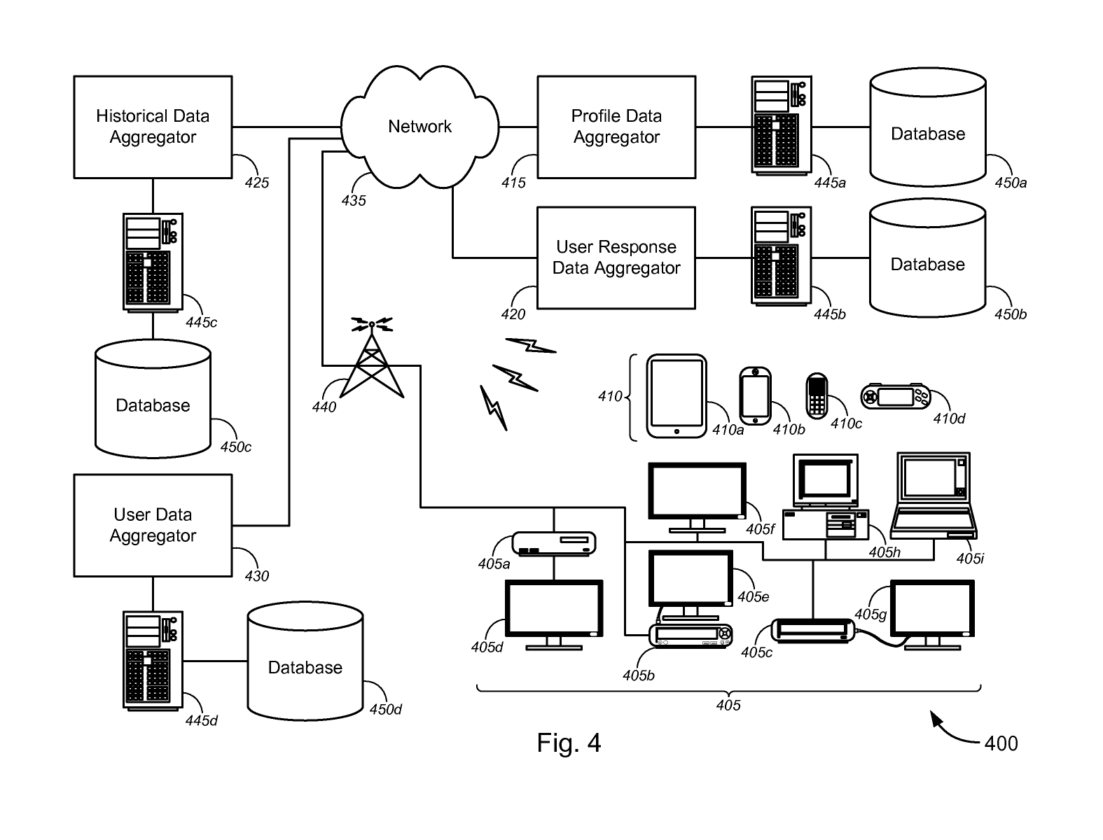

In some embodiments, the identification, matching, and/or grouping functionality described in detail below with respect to FIGS. 4-6 may be applied to the user incentive programs for reward systems described herein with respect to FIGS. 1-3. With reference to the figures, FIG. 1 is a general schematic diagram illustrating a system 100 for implementing adaptable and intelligent user incentives programs for reward systems, in accordance with various embodiments. In FIG. 1, system 100 might comprise one or more user devices 105. The one or more user devices 105 might comprise gaming console 105a, digital video recording and playback device (“DVR”) 105b, set-top or set-back box (“STB”) 105c, one or more television sets (“TVs”) 105d-105g, desktop computer 105h, laptop computer 105i, and one or more mobile user devices 110. The one or more TVs 105d-105g might include any combination of a high-definition (“HD”) television, an Internet Protocol television (“IPTV”), and a cable television, or the like, where one or both of HDTV and IPTV may be interactive TVs. The one or more mobile user devices 110 might comprise one or more tablet computers 110a, one or more smart phones 110b, one or more mobile phones 110c, or one or more portable gaming devices 110d, and/or the like.

System 100 might further comprise server 115 communicatively coupled to the one or more user devices 105 via network 120 (which might be an access network), and in some cases via one or more telecommunications relay systems 125. The one or more telecommunications relay systems 125 might include, without limitation, one or more wireless network interfaces (e.g., wireless modems, wireless access points, and the like), one or more towers, one or more satellites, and the like. System 100 might further comprise database 130 in communication with server 115.

In some embodiments, system 100 might further comprise a plurality of retail computers 135 associated with a plurality of retailers. The plurality of retail computers 135 might be in communication with at least one of the server 115 or the one or more user devices 105 via network 140 and/or via the one or more telecommunications relay systems 125. System 100 might further comprise server 145 and database 150 in communication with one or more of the plurality of retail computers 135.

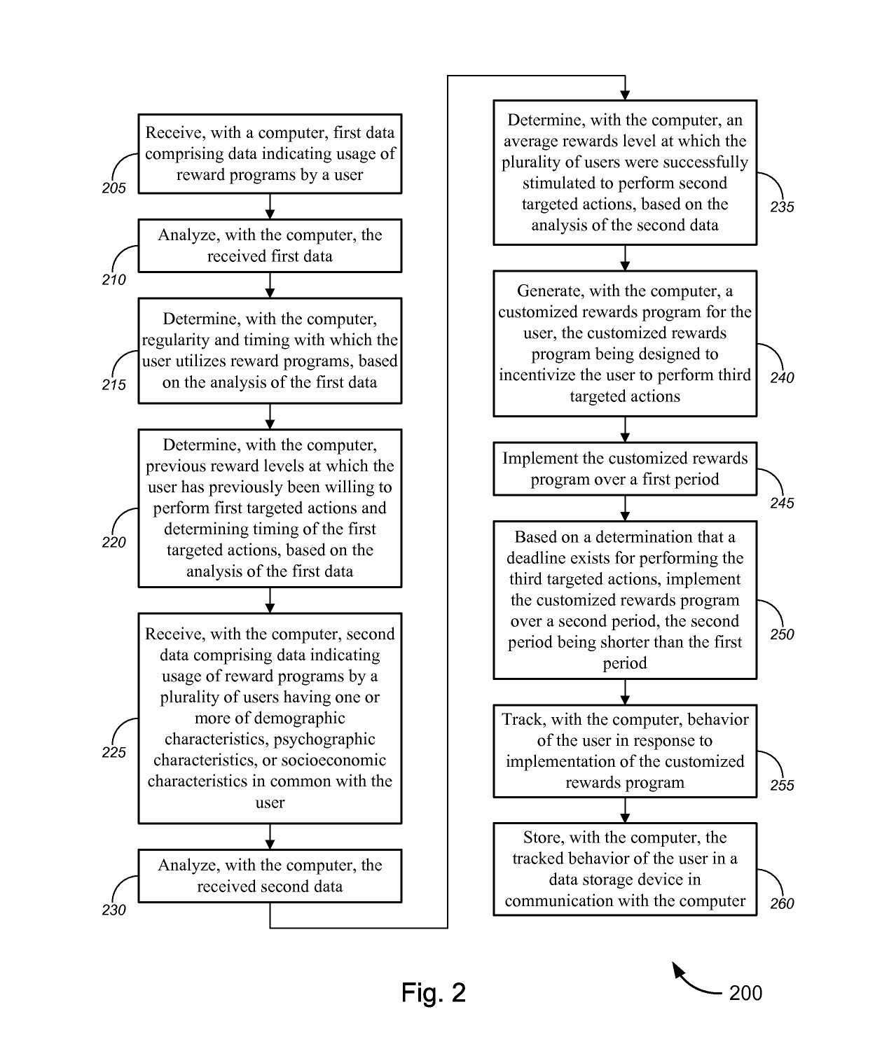

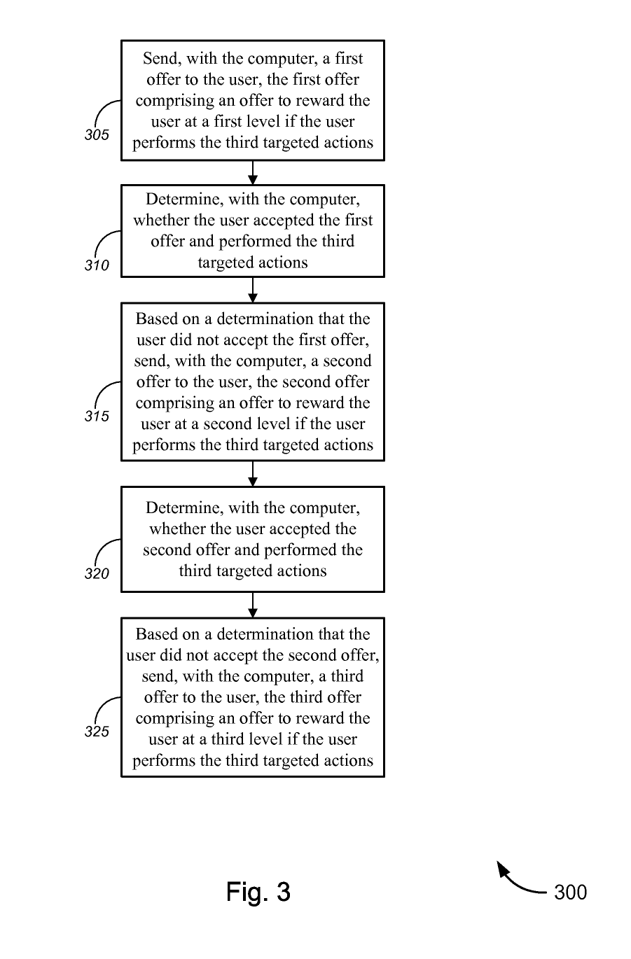

In operation, server 115 might perform the methods described in detail with respect to FIGS. 2 and 3 below, while data associated with usage of reward incentive programs might be collected either by the one or more user devices 105, by the plurality of retail computers 135, or by both. The server 115 may subsequently base its analyses on such data.

We now turn to FIGS. 2 and 3, which are directed to methods 200 and 300 for implementing adaptable and intelligent user incentives programs for reward systems, in accordance with various embodiments. While the techniques and procedures of the methods 200 and 300 are depicted and/or described in a certain order for purposes of illustration, it should be appreciated that certain procedures may be reordered and/or omitted within the scope of various embodiments. Moreover, while the methods illustrated by FIGS. 2 and 3 can be implemented by (and, in some cases, are described below with respect to) systems 100 of FIG. 1 (or components thereof), the method may also be implemented using any suitable hardware implementation. Similarly, while system 100 (and/or components thereof) can operate according to the methods illustrated by FIGS. 2 and/or 3 (e.g., by executing instructions embodied on a computer readable medium), system 100 can also operate according to other modes of operation and/or perform other suitable procedures.

In FIG. 2, method 200 might comprise receiving, with a computer, first data comprising data indicating usage of reward programs by a user (block 205), analyzing, with the computer, the received first data (block 210), and determining, with the computer, regularity and timing with which the user utilizes reward programs, based on the analysis of the first data (block 215). In some embodiments, the computer might be server 115 as shown in and described with respect to FIG. 1. Method 200 might further comprise, at block 220, determining, with the computer, previous reward levels at which the user has previously been willing to perform first targeted actions and determining timing of the first targeted actions, based on the analysis of the first data.

At block 225, method 200 might comprise receiving, with the computer, second data comprising data indicating usage of reward programs by a plurality of users having one or more of demographic characteristics, psychographic characteristics, or socioeconomic characteristics in common with the user. Method 200 might further comprise analyzing, with the computer, the received second data (block 230) and determining, with the computer, an average rewards level at which the plurality of users were successfully stimulated to perform second targeted actions, based on the analysis of the second data (block 235).

Method 200, at block 240, might comprise generating, with the computer, a customized rewards program for the user, the customized rewards program being designed to incentivize the user to perform third targeted actions. At block 245, method 200 might comprise implementing the customized rewards program over a first period. In some embodiments, method 200 might comprise, based on a determination that a deadline exists for performing the third targeted actions, implementing the customized rewards program over a second period, the second period being shorter than the first period (block 250).

At block 255, method 200 might comprise tracking, with the computer, behavior of the user in response to implementation of the customized rewards program. Method 200 might further comprise storing, with the computer, the tracked behavior of the user in a data storage device in communication with the computer (block 260). In some embodiments, storing the tracked behavior of the user might comprise storing the user's behavior (either successful or unsuccessful with respect to accepting the reward and perform the third targeted actions) in the user's profile in order to preserve that pattern of behavior for future reward program implementation, which might be generated based at least in part on such pattern of behavior.

In FIG. 3, which focuses on a particular implementation of the rewards program, method 300 might comprise sending, with the computer, a first offer to the user, the first offer comprising an offer to reward the user at a first level if the user performs the third targeted actions (block 305). At block 310, method 300 might comprise determining, with the computer, whether the user accepted the first offer and performed the third targeted actions. Based on a determination that the user did not accept the first offer, method 300 might comprise sending, with the computer, a second offer to the user, the second offer comprising an offer to reward the user at a second level if the user performs the third targeted actions (block 315). Method 300, at block 320, might comprise determining, with the computer, whether the user accepted the second offer and performed the third targeted actions. At block 325, method 300 might comprise, based on a determination that the user did not accept the second offer, sending, with the computer, a third offer to the user, the third offer comprising an offer to reward the user at a third level if the user performs the third targeted actions.

In some embodiments, the first level might correspond to the average rewards level of the plurality of users, the second level might correspond to an average of the previous reward levels of the user, and the third level might correspond to a predetermined maximum reward level associated with the first targeted actions. According to some embodiments, the first targeted actions, the second targeted actions, and the third targeted actions might be similar targeted actions. In some instances, one or more of the first targeted actions, the second targeted actions, or the third targeted actions might comprise at least one of completing a poll, completing a survey, visiting a webpage, endorsing a product, endorsing a service, endorsing a brand, endorsing a company, purchasing a product, or subscribing to a service.

According to various embodiments, each of the first through third (or other) offers might be automatically generated by the computer and automatically communicated to the user via at least one of one or more e-mail messages, one or more text messages, one or more chat messages, one or more short message service (“SMS”) messages, and/or one or more multi-media messaging service (“MMS”) messages, or the like. The techniques and systems described above allow for mass-scale data aggregation and mass-scale analysis (that, in some embodiments, require highly networked, Internet-based, mass-scale data aggregation and mass-scale analysis, as well as automated generation of messages containing offers to users) to provide near-instantaneous generation and updating of customized user incentive programs that are based at least in part on the user's behavior and history and at least in part on characteristics of a plurality of users sharing common characteristics with the user.

Identification, Matching, and/or Grouping of Users

In some embodiments, the identification, matching, and/or grouping functionality described in detail below with respect to FIGS. 4-6 may be applied to the user incentive programs for reward systems described above with respect to FIGS. 1-3. With reference to the figures, FIG. 4 is a general schematic diagram illustrating a system 400 for implementing adaptable and intelligent identification, matching, and/or grouping of users, in accordance with various embodiments. In FIG. 4, system 400 might comprise one or more user devices 405. The one or more user devices 405 might comprise gaming console 405a, digital video recording and playback device (“DVR”) 405b, set-top or set-back box (“STB”) 405c, one or more television sets (“TVs”) 405d-405g, desktop computer 405h, laptop computer 405i, and one or more mobile user devices 410. The one or more TVs 405d-405g might include any combination of a high-definition (“HD”) television, an Internet Protocol television (“IPTV”), and a cable television, or the like, where one or both of HDTV and IPTV may be interactive TVs. The one or more mobile user devices 410 might comprise one or more tablet computers 410a, one or more smart phones 410b, one or more mobile phones 410c, or one or more portable gaming devices 410d, and/or the like.

System 400 might further comprise profile data aggregator 415, opinion data aggregator 420, historical data aggregator 425, and user data aggregator 430 (collectively, “data aggregators”), each communicatively coupled to the one or more user devices 405 via network 435 (which might be an access network), and in some cases via one or more telecommunications relay systems 440. The one or more telecommunications relay systems 440 might include, without limitation, one or more wireless network interfaces (e.g., wireless modems, wireless access points, and the like), one or more towers, one or more satellites, and the like. System 400 might further comprise one or more profile data servers 445a, one or more user-response/opinion data servers 445b, one or more historical data servers 445c, and one or more user data servers 445d (collectively, “servers 445”). System 400 might also comprise one or more profile data databases 450a, one or more user-response/opinion data databases 450b, one or more historical data databases 450c, and one or more user data databases 450d (collectively, “data stores 450” or “databases 450”).

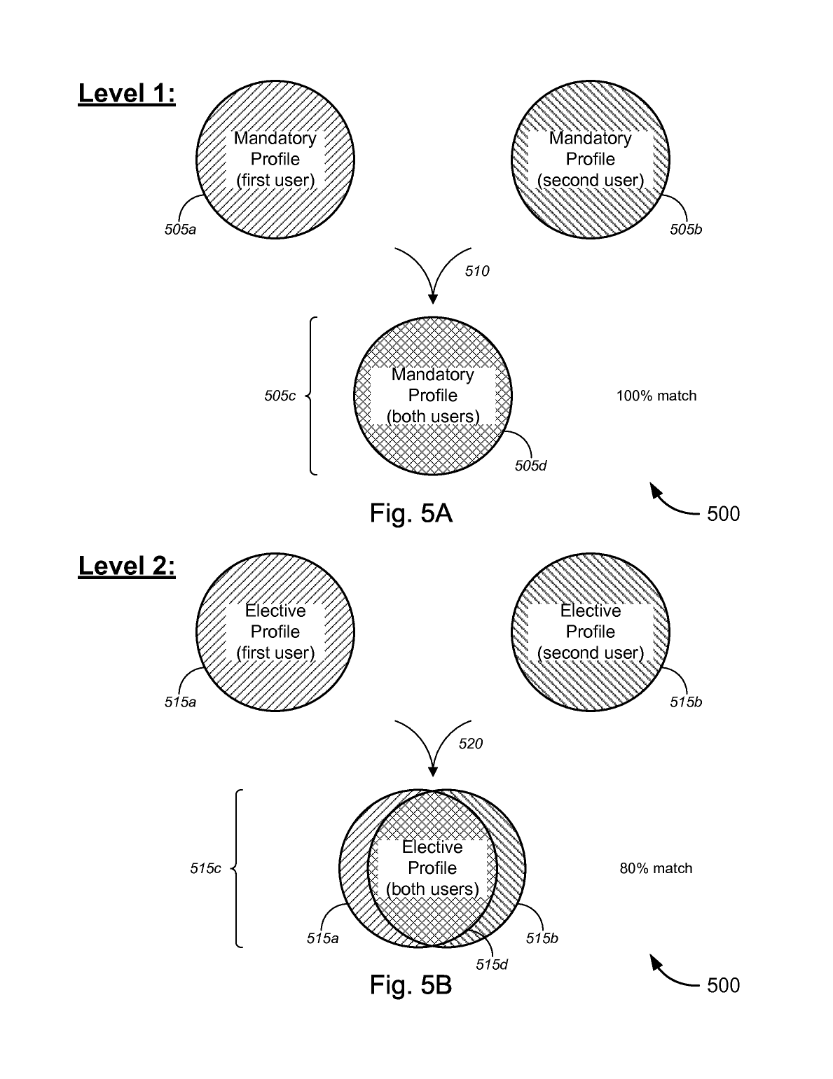

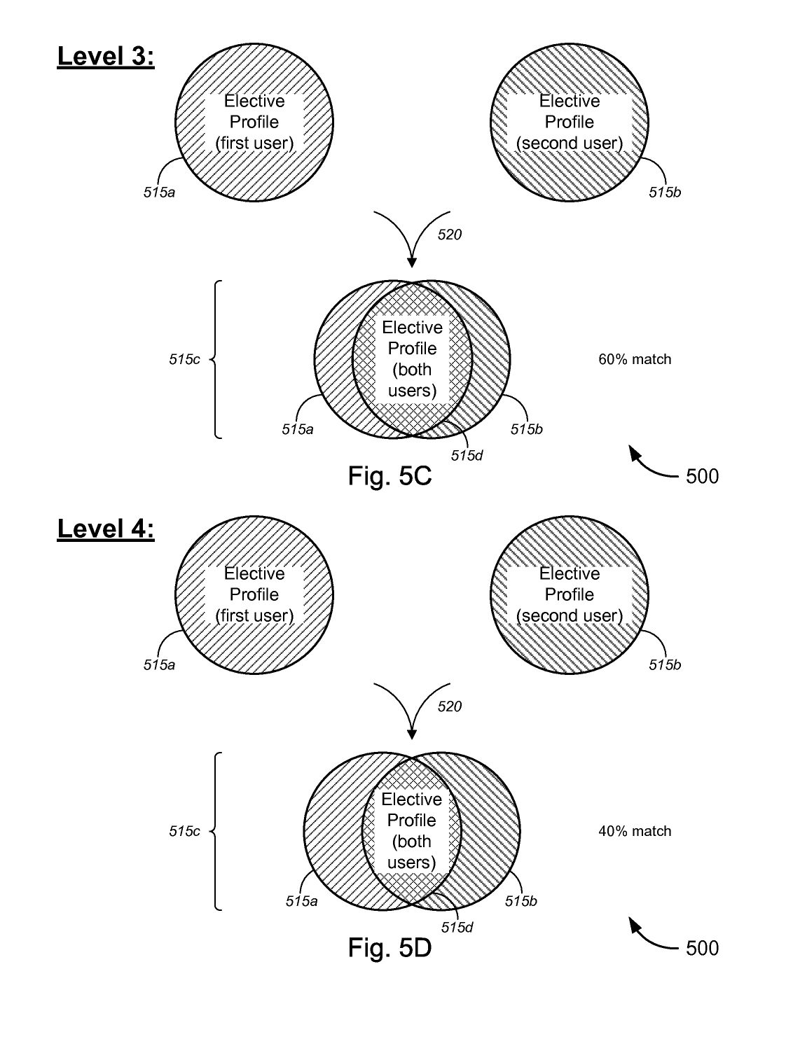

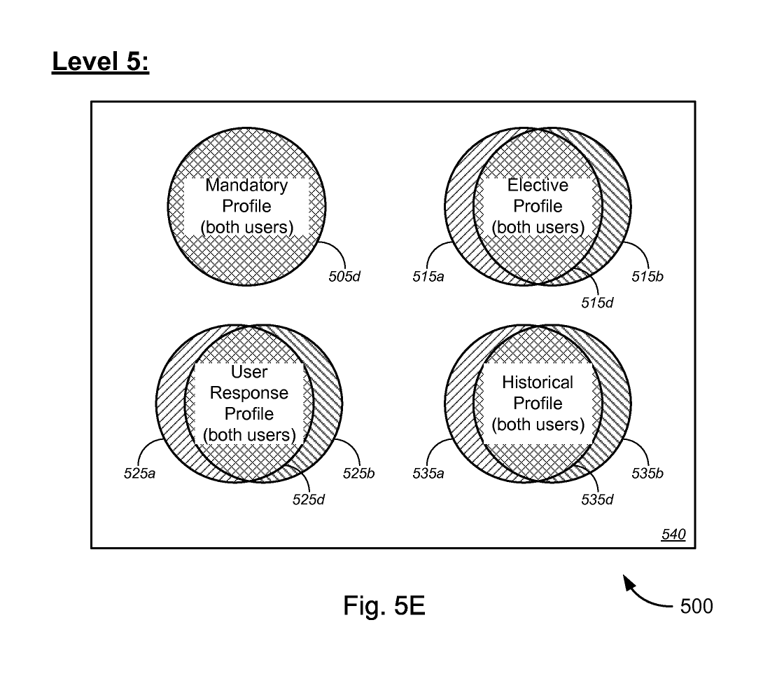

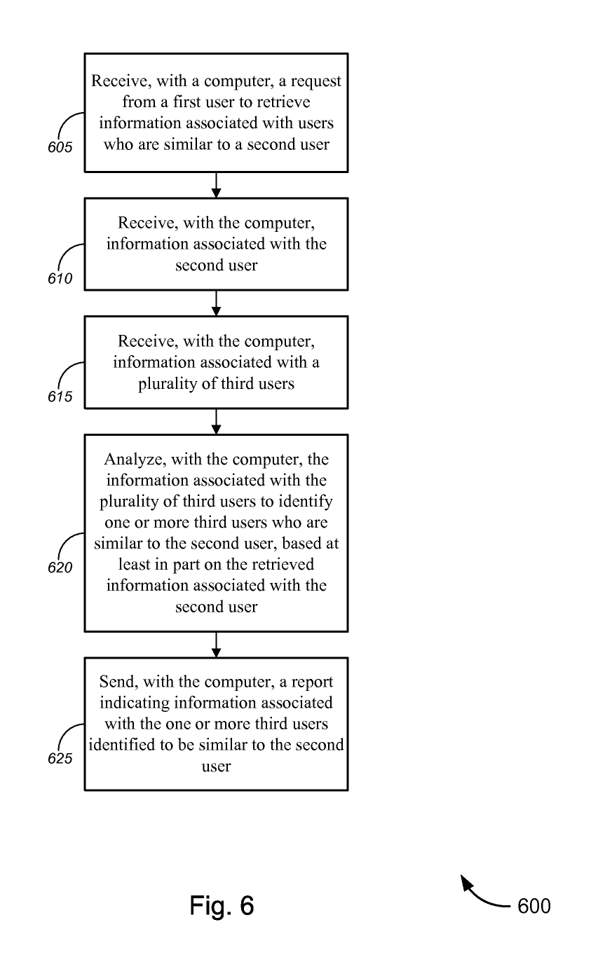

In operation, the data aggregators, servers 445, and/or the data stores 450 might perform the methods described in detail with respect to FIGS. 5 and 6 below, while data associated with the users might be collected either by the one or more user devices 405, by the data aggregators 415-430, by the servers 445, or by any combination of these components.

We now turn to FIGS. 5 and 6, which are directed to methods 500 and 600 for implementing adaptable and intelligent identification, matching, and/or grouping of users, in accordance with various embodiments. While the techniques and procedures of the methods 500 and 600 are depicted and/or described in a certain order for purposes of illustration, it should be appreciated that certain procedures may be reordered and/or omitted within the scope of various embodiments. Moreover, while the methods illustrated by FIGS. 5 and 6 can be implemented by (and, in some cases, are described below with respect to) systems 400 of FIG. 4 (or components thereof), the method may also be implemented using any suitable hardware implementation. Similarly, while system 400 (and/or components thereof) can operate according to the methods illustrated by FIGS. 5 and/or 6 (e.g., by executing instructions embodied on a computer readable medium), system 400 can also operate according to other modes of operation and/or perform other suitable procedures.

We turn now to FIGS. 5A-5E (collectively, “FIG. 5”), which are general schematic diagrams illustrating levels of matching for implementing adaptable and intelligent identification, matching, and/or grouping of users, in accordance with various embodiments. In FIG. 5, five levels of identification, matching, and/or grouping are utilized. This figure, however, is merely provided for illustration, and any suitable number of levels of identification, matching, and/or grouping may be implemented, with any suitable number of responders and/or amount of time being used, and/or the like.

In the example of FIG. 5, Level 1, as shown in FIG. 5A, might comprise determining whether the mandatory profiles 505b of any of a plurality of second users matches the mandatory profile 505a of a first user (i.e., a requesting or target user). (For the sake of illustration, only the profiles of one second user are shown in FIG. 5A, although the profiles of two or more second users may be compared with the mandatory profile of the first user.) In particular, for a second user to be determined to be similar to the first user, the mandatory profile 505b for the second user must match 100% with the mandatory profile 505a for the first user. In other words, the combination 505c of the mandatory profiles 505a and 505b in the process represented by arrows 510 should result in a combined mandatory profile 505d that is exactly overlapped with each of the mandatory profiles 505a and 505b. In some embodiments, each mandatory profile 505a and 505b might include, without limitation, gender, year of birth (plus or minus 2 years), marital status, educational level, and/or the like. The one or more second users whose mandatory profiles 505b match the mandatory profiles 505a of the first user by 100% are used for further matching in Levels 2-5 described below.

Level 2, as shown in FIG. 5B, might comprise determining whether there is an at least 80% match between the elective profiles 515b of any of the one or more second users (whose mandatory profiles 505b match mandatory profile 505a of the first user, as described above with respect to FIG. 5A) and the elective profile 515a of the first user (i.e., a requesting or target user). (As above, for the sake of illustration, only the profiles of one second user are shown in FIG. 5B.) In particular, for a second user to be determined to be similar to the first user, both the mandatory profile 505b for the second user must match 100% with the mandatory profile 505a for the first user and the elective profiles 505b for the second user must match at least 80% with the elective profile 515a for the first user. In other words, the combination 515c of the elective profiles 515a and 515b in the process represented by arrows 520 should result in a combined elective profile 515d that is overlapped with each of the elective profiles 515a and 515b by at least 80%, as shown in FIG. 5B. In some embodiments, each elective profile 515a and 515b might include, without limitation, demographic characteristics (e.g., political affiliation, ethnicity, knowledge of languages, disabilities, mobility, home ownership, employment status, location, and/or the like), psychographic characteristics, and socioeconomic characteristics, and/or the like. In some embodiments, a poll or survey may be sent to the one or more second users whose elective profiles match at least 80%.

If after a predetermined period (including, but not limited to, 60 minutes, 90 minutes, 420 minutes, and/or the like) less than a predetermined number (including, without limitation, 20, 40, 60, and/or the like) of polls or surveys are returned, then the process might proceed to Level 3. Level 3, as shown in FIG. 5C, might comprise determining whether there is an at least 60% match between the elective profiles 515b of any of the one or more second users (whose mandatory profiles 505b match mandatory profile 505a of the first user, as described above with respect to FIG. 5A) and the elective profile 515a of the first user (i.e., a requesting or target user). In particular, for a second user to be determined to be similar to the first user, both the mandatory profile 505b for the second user must match 100% with the mandatory profile 505a for the first user and the elective profiles 505b for the second user must match at least 60% with the elective profile 515a for the first user. In other words, the combination 515c of the elective profiles 515a and 515b in the process represented by arrows 520 should result in a combined elective profile 515d that is overlapped with each of the elective profiles 515a and 515b by at least 60%, as shown in FIG. 5C. In some embodiments, the same or similar poll or survey may be sent to the one or more second users whose elective profiles match at least 60%.

If after a predetermined period (including, but not limited to, 60 minutes, 90 minutes, 420 minutes, and/or the like) less than a predetermined number (including, without limitation, 20, 40, 60, and/or the like) of polls or surveys are returned, then the process might proceed to Level 4. Level 4, as shown in FIG. 5D, might comprise determining whether there is an at least 40% match between the elective profiles 515b of any of the one or more second users (whose mandatory profiles 505b match mandatory profile 505a of the first user, as described above with respect to FIG. 5A) and the elective profile 515a of the first user (i.e., a requesting or target user). In particular, for a second user to be determined to be similar to the first user, both the mandatory profile 505b for the second user must match 100% with the mandatory profile 505a for the first user and the elective profiles 505b for the second user must match at least 40% with the elective profile 515a for the first user. In other words, the combination 515c of the elective profiles 515a and 515b in the process represented by arrows 520 should result in a combined elective profile 515d that is overlapped with each of the elective profiles 515a and 515b by at least 40%, as shown in FIG. 5D. In some embodiments, the same or similar poll or survey may be sent to the one or more second users whose elective profiles match at least 40%.

According to some embodiments, the results of the polls or surveys returned by one or more second users might be analyzed. In some cases, each user might be assigned an identifying category number. The number might identify the group of second users who answered questions more closely to each other. In other words, each answer, for each poll or survey question, for all polls answered, may be analyzed and the second users who have the highest matches of answered questions might be assigned the same number. The answers for polls or surveys (which might be on a daily or weekly basis) may subsequently be reviewed and the identifying category number may be updated accordingly. In some embodiments, the results of the profile matching analysis (as described above with respect to FIGS. 5A-5D) as well as the results of the polls answer matching may be coupled. Polls may then be distributed to those users who match in profiles (and the users may be provided permission and/or access to view results from each other who match in profiles).

In a similar manner as described above, it may be determined whether or not the survey or poll responses of the one or more second users (whose elective profiles match at least 40%, at least 60%, at least 80%) may be compared with the survey or poll responses of the first user. The one or more second users whose survey or poll response match at least 40%, at least 60%, or at least 80% of the survey or poll responses of the first user may be grouped together. Likewise, it may be determined whether or not historical data of the one or more second users (whose elective profiles match at least 40%, at least 60%, at least 80%) may be compared with the historical data of the first user. The one or more second users whose historical data match at least 40%, at least 60%, or at least 80% of the survey or poll responses of the first user may be grouped together. Herein, historical data might include, but is not limited to, product purchase histories, service purchase histories, book purchase histories, library book loan histories, newspaper subscription histories, magazine subscription histories, entertainment program subscription histories, entertainment program venue ticket purchase histories, Internet browser histories, search histories, voting records, charitable donation records, online dating patterns, meta data associated with product purchase histories, meta data associated with service purchase histories, meta data associated with book purchase histories, meta data associated with library book loan histories, meta data associated with newspaper subscription histories, meta data associated with magazine subscription histories, meta data associated with entertainment program subscription histories, meta data associated with entertainment program venue ticket purchase histories, meta data associated with Internet browser histories, meta data associated with search histories, meta data associated with voting records, meta data associated with charitable donation records, meta data associated with online dating patterns, and/or the like.

In this manner, level 5, as shown in FIG. 5E, might comprise aggregating each of the second users who are similar to the first user (as well as the profiles thereof) into group 540. That is, the second users being aggregated are users whose: mandatory profiles 505b match 100% with the mandatory profile of the first user; elective profiles 515b match one of at least 40%, at least 60%, or at least 80% with the elective profile 515a of the first user (i.e., to form a combined elective profile 515d); user response profiles 525b match one of at least 40%, at least 60%, or at least 80% with the user response profile 525a of the first user (i.e., to form a combined user response profile 525d); and historical profiles 535b match one of at least 40%, at least 60%, or at least 80% with the historical profile 535a of the first user (i.e., to form a combined historical profile 535d).

In FIG. 6, which is a general schematic flow diagram illustrating a method 600 for implementing adaptable and intelligent identification, matching, and/or grouping of users, method 600 might comprise receiving, with a computer, a request from a first user to retrieve information associated with users who are similar to a second user (block 605). The request from the first user to retrieve information associated with users who are similar to the second user might comprise the first user performing an action selected from a group consisting of actuating a hard-button, actuating a soft-button, actuating a virtual button, clicking on a link, and initiating a voice command.

In some embodiments, the second user and the first user might be the same user. In some cases, the second user might be one of a significant other (e.g., a spouse, a boyfriend, a girlfriend, and/or the like) of the first user, a relative of the first user, a friend of the first user, an acquaintance of the first user, or a co-worker of the first user.

Alternatively, the first user might be one of a retailer or a representative of the retailer, and the second user might be a customer of the first user. In such cases, the method 600 might further comprise receiving, with the computer, a request from the first user to send the report to the second user, and in response to receiving the request, sending, with the computer and to the second user, the report indicating information associated with the one or more third users identified to be similar to the second user. In some aspects, the method might further comprise generating, with the computer, a customized rewards program for the second user based at least in part on the report indicating information associated with the one or more third users identified to be similar to the second user, and implementing the customized rewards program. Generation and implementation of the customized rewards program is described in detail above with respect to FIGS. 1-3.

At block 610, method 600 might comprise receiving, with the computer, information associated with the second user. Method 600 might further comprise receiving, with the computer, information associated with a plurality of third users (block 615). In some embodiments, the information associated with the second user might comprise at least one of first profile characteristics, first user-response characteristics, or first historical characteristics, and the information associated with the plurality of third users might comprise at least one of second profile characteristics, second user-response characteristics, or second historical characteristics.

Each of the first profile characteristics or the second profile characteristics might comprise characteristics selected from a group consisting of demographic characteristics, psychographic characteristics, and socioeconomic characteristics. Each of the second user-response characteristics or the second user-response characteristics might comprise characteristics selected from a group consisting of poll response data and survey response data. Each of the first historical characteristics or the second historical characteristics might comprise characteristics selected from a group consisting of product purchase histories, service purchase histories, book purchase histories, library book loan histories, newspaper subscription histories, magazine subscription histories, entertainment program subscription histories, entertainment program venue ticket purchase histories, Internet browser histories, search histories, voting records, charitable donation records, online dating patterns, meta data associated with product purchase histories, meta data associated with service purchase histories, meta data associated with book purchase histories, meta data associated with library book loan histories, meta data associated with newspaper subscription histories, meta data associated with magazine subscription histories, meta data associated with entertainment program subscription histories, meta data associated with entertainment program venue ticket purchase histories, meta data associated with Internet browser histories, meta data associated with search histories, meta data associated with voting records, meta data associated with charitable donation records, and meta data associated with online dating patterns.

In some embodiments, receiving information associated with the second user might comprise retrieving at least one of first profile characteristics, first user-response characteristics, or first historical characteristics from one or more first data stores. In other embodiments, receiving information associated with the second user might comprise sending one or more requests to the second user to provide information regarding at least one of first profile characteristics, first user-response characteristics, or first historical characteristics. Likewise, receiving information associated with the plurality of third users, in some cases, might comprise retrieving at least one of second profile characteristics, second user-response characteristics, or second historical characteristics from one or more second data stores. In other cases, receiving information associated with the plurality of third users might comprise sending requests to at least one third user of the plurality of third users to provide information regarding at least one of second profile characteristics, second user-response characteristics, or second historical characteristics.

Method 600, at block 620, might comprise analyzing, with the computer, the information associated with the plurality of third users to identify one or more third users who are similar to the second user, based at least in part on the retrieved information associated with the second user. Analyzing the information associated with the plurality of third users to identify the one or more third users who are similar to the second user might, in some instances, comprise at least one of determining whether the first profile characteristics of the second user match with the second profile characteristics of any of the plurality of third users, determining whether the second user-response characteristics of the second user match with the second user-response characteristics of any of the plurality of third users, or determining whether the first historical characteristics of the second user match with the second historical characteristics of any of the plurality of third users.

At block 625, method 600 might comprise sending, with the computer and to the first user, a report indicating information associated with the one or more third users identified to be similar to the second user. According to some embodiments, sending the report indicating information associated with the one or more third users identified to be similar to the second user might comprise aggregating at least one of second profile characteristics, second user-response characteristics, or second historical characteristics. The report indicating information associated with the one or more third users identified to be similar to the second user might be automatically generated by the computer and automatically communicated to user, and might comprise at least one of one or more graphs, one or more spreadsheets, one or more comma-separated values (“CSV”) files, one or more text files, one or more images, one or more e-mail messages, one or more text messages, one or more chat messages, one or more short message service (“SMS”) messages, or one or more multi-media messaging service (“MMS”) messages. The information associated with the one or more third users identified to be similar to the second user might comprise at least one of product reviews, service reviews, poll responses, survey responses, book reviews, magazine reviews, newspaper reviews, entertainment program reviews, entertainment venue reviews, Internet website reviews, political commentaries, charity reviews, or dating website reviews. The techniques and systems described above allow for mass-scale data aggregation and mass-scale analysis (that, in some embodiments, require highly networked, Internet-based, mass-scale data aggregation and mass-scale analysis, as well as automated generation of reports to users) to provide near-instantaneous reporting to a user of opinions and/or responses of a plurality of users sharing common characteristics with the user (the opinions and/or responses helping the user when answering polls, purchasing items, and/or the like).

System and Hardware Implementation

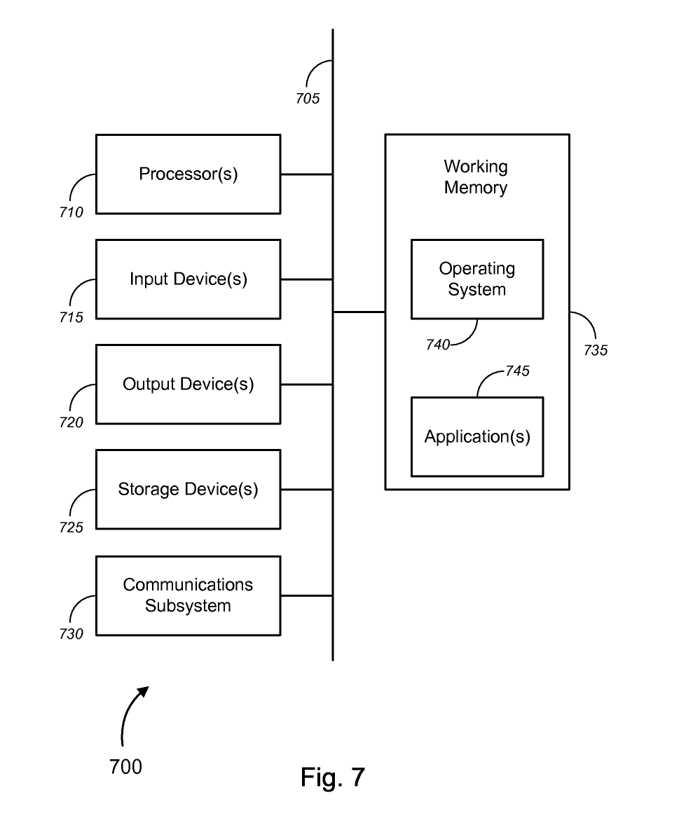

We now turn to FIG. 7, which is a block diagram illustrating an exemplary computer architecture. FIG. 7 provides a schematic illustration of one embodiment of a computer system 700 that can perform the methods provided by various other embodiments, as described herein, and/or can perform the functions of local computer system 105, 110, 135, 145, 405, or 410, or remote computer system 115, 415, 420, 425, 430, 445, or other computer systems as described above. It should be noted that FIG. 7 is meant only to provide a generalized illustration of various components, of which one or more, or none, of each may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705, or may otherwise be in communication, as appropriate. The hardware elements may include one or more processors 710, including without limitation one or more general-purpose processors, or one or more special-purpose processors such as digital signal processing chips, graphics acceleration processors, or the like; one or more input devices 715, which can include without limitation a mouse, a keyboard, or the like; and one or more output devices 720, which can include without limitation a display device, a printer, or the like.

The computer system 700 may further include, or be in communication with, one or more storage devices 725. The one or more storage devices 725 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 700 might also include a communications subsystem 730, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 730 may permit data to be exchanged with a network (such as network 120, 140, or 435, to name examples), with other computer systems, with any other devices described herein, or with any combination of network, systems, and devices. According to some embodiments, network 120 (as well as networks 140 and 435) might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 700 will further comprise a working memory 735, which can include a RAM or ROM device, as described above.

The computer system 700 may also comprise software elements, shown as being currently located within the working memory 735, including an operating system 740, device drivers, executable libraries, or other code. The software elements may include one or more application programs 745, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 725 described above. In some cases, the storage medium might be incorporated within a computer system, such as the system 700. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 700, or might take the form of source or installable code. The source or installable code, upon compilation, installation, or both compilation and installation, on the computer system 700 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 700, to perform methods in accordance with various embodiments of the invention. According to a set of embodiments, some or all of the procedures of such methods might be performed by the computer system 700 in response to processor 710 executing one or more sequences of one or more instructions. The one or more instructions might be incorporated into the operating system 740 or other code that may be contained in the working memory 735, such as an application program 745. Such instructions may be read into the working memory 735 from another computer readable medium, such as one or more of the storage devices 725. Merely by way of example, execution of the sequences of instructions contained in the working memory 735 might cause the one or more processors 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 700, various computer readable media might be involved in providing instructions or code to the one or more processors 710 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 725. Volatile media includes, without limitation, dynamic memory, such as the working memory 735. Transmission media includes, without limitation, coaxial cables, copper wire and fiber optics, including the wires that comprise the bus 705, as well as the various components of the communication subsystem 730, or the media by which the communications subsystem 730 provides communication with other devices. Hence, transmission media can also take the form of waves, including without limitation radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

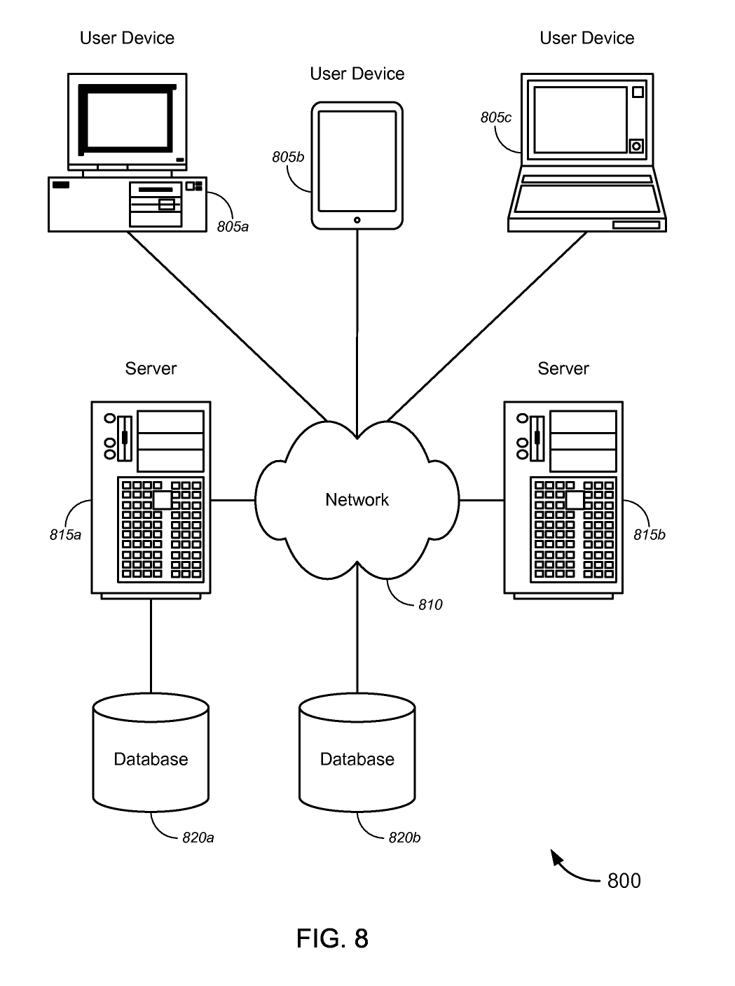

As noted above, a set of embodiments comprises methods and systems for implementing adaptable and intelligent user incentives programs for reward systems or for implementing adaptable and intelligent identification, matching, and/or grouping of users. FIG. 8 illustrates a schematic diagram of a system 800 that can be used in accordance with one set of embodiments. The system 800 can include one or more user computers or user devices 805. A user computer or user device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 805 can also have any of a variety of applications, including one or more applications configured to perform methods provided by various embodiments (as described above, for example), as well as one or more office applications, database client and/or server applications, and/or web browser applications. Alternatively, a user computer or user device 805 can be any other electronic device, such as a thin-client computer, Internet-enabled mobile telephone, and/or personal digital assistant, capable of communicating via a network (e.g., the network 810 described below) and/or of displaying and navigating web pages or other types of electronic documents. Although the exemplary system 800 is shown with three user computers or user devices 805, any number of user computers or user devices can be supported.

Certain embodiments operate in a networked environment, which can include a network 810. The network 810 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 810 can include a local area network (“LAN”), including without limitation a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 might be a data server, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer or user device 805 and/or another server 815. In some embodiments, an application server can perform one or more of the processes for implementing adaptable and intelligent user incentives programs for reward systems or for implementing adaptable and intelligent identification, matching, and/or grouping of users, or the like, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer or user device 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: merely by way of example, a database 820a might reside on a storage medium local to (and/or resident in) a server 815a (and/or a user computer or user device 805). Alternatively, a database 820b can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computer, first data comprising data indicating usage of reward programs by a user;
analyzing, with the computer, the received first data;
determining, with the computer, regularity and timing with which the user utilizes reward programs, based on the analysis of the first data;
determining, with the computer, previous reward levels at which the user has previously been willing to perform first targeted actions and determining timing of the first targeted actions, based on the analysis of the first data;
receiving, with the computer, second data comprising data indicating usage of reward programs by a plurality of users having one or more of demographic characteristics, psychographic characteristics, or socioeconomic characteristics in common with the user;
analyzing, with the computer, the received second data;
determining, with the computer, an average rewards level at which the plurality of users were successfully stimulated to perform second targeted actions, based on the analysis of the second data;
generating, with the computer, a customized rewards program for the user, the customized rewards program being designed to incentivize the user to perform third targeted actions;
implementing the customized rewards program;
tracking, with the computer, behavior of the user in response to implementation of the customized rewards program; and
storing, with the computer, the tracked behavior of the user in a data storage device in communication with the computer.

2. The method of claim 1, wherein the computer is a server in a network.

3. The method of claim 1, wherein the customized rewards program comprises step-wise incremental rewards incentives, wherein the step-wise incremental rewards incentives comprises a first level corresponding to the average rewards level of the plurality of users, a second level corresponding to an average of the previous reward levels of the user, and a third level corresponding to a predetermined maximum reward level associated with the first targeted actions.

4. The method of claim 3, wherein implementing the customized rewards program comprises:
sending, with the computer, a first offer to the user, the first offer comprising an offer to reward the user at the first level if the user performs the third targeted actions;
determining, with the computer, whether the user accepted the first offer and performed the third targeted actions;
based on a determination that the user did not accept the first offer, sending, with the computer, a second offer to the user, the second offer comprising an offer to reward the user at the second level if the user performs the third targeted actions;
determining, with the computer, whether the user accepted the second offer and performed the third targeted actions;
based on a determination that the user did not accept the second offer, sending, with the computer, a third offer to the user, the third offer comprising an offer to reward the user at the third level if the user performs the third targeted actions.

5. The method of claim 1, wherein implementing the customized rewards program comprises implementing the customized rewards program over a first period, wherein the method further comprises determining whether a deadline exists for performing the third targeted actions, wherein implementing the customized rewards program further comprises:
based on a determination that a deadline exists for performing the third targeted actions, implementing the customized rewards program over a second period, the second period being shorter than the first period.

6. The method of claim 1, wherein the first targeted actions, the second targeted actions, and the third targeted actions are similar targeted actions.

7. The method of claim 1, wherein one or more of the first targeted actions, the second targeted actions, or the third targeted actions comprises at least one of completing a poll, completing a survey, visiting a webpage, endorsing a product, endorsing a service, endorsing a brand, endorsing a company, purchasing a product, or subscribing to a service.

8. A method, comprising:
analyzing, with a computer, first data to determine a first level, the first data comprising data indicating first behavior of a user in response to implementation of a plurality of first reward programs;
analyzing, with the computer, second data to determine a second level, the second data comprising data indicating second behavior of a plurality of users in response to implementation of a plurality of second reward programs, the plurality of users having one or more of demographic characteristics, psychographic characteristics, or socioeconomic characteristics in common with the user;
generating, with the computer, a customized rewards program for the user that is designed to incentivize the user to perform first targeted actions, based at least in part on the analysis of the first data and the analysis of the second data;
implementing the customized rewards program;
tracking, with the computer, behavior of the user in response to implementation of the customized rewards program; and
storing, with the computer, the tracked behavior of the user in a data storage device in communication with the computer.

9. The method of claim 8, wherein the first level corresponds to an average level at which the user has previously been willing to perform second targeted actions, and wherein the second level corresponds to an average level at which the plurality of users were successfully stimulated to perform third targeted actions.

10. The method of claim 9, wherein implementing the customized rewards program comprises:
sending, with the computer, a first offer to the user, the first offer comprising an offer to reward the user at the second level if the user performs the first targeted actions;
based on a determination that the user did not accept the first offer, sending, with the computer, a second offer to the user, the second offer comprising an offer to reward the user at the first level if the user performs the first targeted actions;
based on a determination that the user did not accept the second offer, sending, with the computer, a third offer to the user, the third offer comprising an offer to reward the user at a third level if the user performs the first targeted actions, the third level corresponding to a predetermined maximum reward level associated with the first targeted actions.

11. The method of claim 8, wherein implementing the customized rewards program comprises:
implementing the customized rewards program over a first period; and
based on a determination that a deadline exists for performing the third targeted actions, implementing the customized rewards program over a second period, the second period being shorter than the first period.

12. The method of claim 9, wherein the first targeted actions, the second targeted actions, and the third targeted actions are similar targeted actions.

13. The method of claim 1, wherein one or more of the first targeted actions, the second targeted actions, or the third targeted actions comprises at least one of completing a poll, completing a survey, visiting a webpage, endorsing a product, endorsing a service, endorsing a brand, endorsing a company, purchasing a product, or subscribing to a service.

14. An apparatus, comprising:
at least one processor; and
a computer readable storage medium in communication with the at least one processor, the computer readable storage medium having stored thereon computer software, the computer software comprising a set of instructions that, when executed by the at least one processor, causes the apparatus to perform one or more operations, the set of instructions comprising:
instructions to analyze first data to determine a first level, the first data comprising data indicating first behavior of a user in response to implementation of a plurality of first reward programs;
instructions to analyze second data to determine a second level, the second data comprising data indicating second behavior of a plurality of users in response to implementation of a plurality of second reward programs, the plurality of users having one or more of demographic characteristics, psychographic characteristics, or socioeconomic characteristics in common with the user;
instructions to generate a customized rewards program for the user that is designed to incentivize the user to perform first targeted actions, based at least in part on the analysis of the first data and the analysis of the second data;
instructions to implement the customized rewards program;
instructions to track behavior of the user in response to implementation of the customized rewards program; and
instructions to store the tracked behavior of the user in a data storage device in communication with the apparatus.

15. A system, comprising:
a data storage device;
a computer in communication with the data storage device, the computer comprising:
at least one processor; and
a computer readable storage medium in communication with the at least one processor, the computer readable storage medium having stored thereon computer software, the computer software comprising a set of instructions that, when executed by the at least one processor, causes the computer to perform one or more operations, the set of instructions comprising:
instructions to analyze first data to determine a first level, the first data comprising data indicating first behavior of a user in response to implementation of a plurality of first reward programs;
instructions to analyze second data to determine a second level, the second data comprising data indicating second behavior of a plurality of users in response to implementation of a plurality of second reward programs, the plurality of users having one or more of demographic characteristics, psychographic characteristics, or socioeconomic characteristics in common with the user;
instructions to generate a customized rewards program for the user that is designed to incentivize the user to perform first targeted actions, based at least in part on the analysis of the first data and the analysis of the second data;
instructions to implement the customized rewards program;
instructions to track behavior of the user in response to implementation of the customized rewards program; and
instructions to store the tracked behavior of the user in the data storage device.

16. The system of claim 15, further comprising:
a plurality of retail computers associated with a plurality of retailers, wherein the first data and second data are received by the computer from the plurality of retail computers.

17. The system of claim 15, further comprising:
a plurality of user devices each associated with one of the user or one of the plurality of users, wherein the first data and second data are received by the computer from the plurality of user devices.
